(19) United States
(12) Patent Application Publication
(10) Pub. No.: US 2021/0354307 A1
(43) Pub. Date: Nov. 18, 2021

(54) ACTION ROBOT CONTENT SELLING SERVICE OPERATING DEVICE AND OPERATING METHOD THEREOF

(71) Applicant: LG ELECTRONICS INC., Seoul (KR)

(72) Inventors: Kiwoong KIM, Seoul (KR); Mojeong KIM, Seoul (KR); Sanghun KIM, Seoul (KR); Soomin SHIM, Seoul (KR)

(73) Assignee: LG ELECTRONICS INC., Seoul (KR)

(21) Appl. No.: 16/603,944

(22) PCT Filed: Dec. 27, 2018
(86) PCT No.: PCT/KR2018/016757

§ 371 Date: Oct. 9, 2019

(51) Int. Cl. B25J 11/00; B25J 9/16; G06Q 30/06; G06F 16/44

(52) U.S. Cl. CPC B25J 11/0035; B25J 9/1602; G06F 16/44; G06Q 30/0619; B25J 9/1664

(57) ABSTRACT

A content selling service operating device according to an embodiment of the present disclosure comprises: a communication interface connected to a terminal of a user to receive, from the terminal, a request for purchasing action robot content corresponding to multimedia content; an action robot content generator configured to generate action robot content including motion data for the multimedia content; and a processor configured to control the communication interface to transmit the generated action robot content to an action robot or the terminal of the user.

### BACKGROUND

### 1. Field

The present disclosure relates to an action robot content selling service operating device for providing action robot content including motion data corresponding to multimedia content of a content provider.

### 2. Background

As the robot technology develops, a method of constructing a robot by modularizing a joint or a wheel is used. For example, a plurality of actuator modules constituting a robot are electrically and mechanically connected and assembled to make various types of robots such as dogs, dinosaurs, humans, and spiders.

A robot that can be manufactured by assembling the plurality of actuator modules is generally called a modular robot. Each of the actuator modules constituting the modular robot has a motor therein, and motion of the robot is executed according to the rotation of the motor. The motion of such a robot is a concept that collectively refers to the motion of the robot such as action, dance, and the like.

In recent years, entertainment robots have become prominent, and interest in robots for enhancing entertainment or people's interest has been increasing. For example, there have been developed techniques for dancing to music or taking a motion or a facial expression according to a story (a fairy tale or the like).

The action robot performs a motion in such a manner that a plurality of motions that match your music or fairy tale are preset and the preset motion is executed when the music or fairy tale is played back from an external device.

However, the related art does not provide an interface or the like for generating motion data for each of various contents, and is merely to cause the action robot to take the motion by using only predefined motion data for some contents provided by a manufacturer.

A user may use a variety of multimedia content such as music through a robot such as an action robot. To this end, it is necessary to implement a system (server, etc.) capable of integrally managing the multimedia contents and the corresponding motion data and providing content desired by the user.

In addition, as the types of action robots are diversified, the number and positions of the joints of the action robots may be varied, and the motions that can be performed by the action robots may be changed. That is, as the types of action robots become various, various kinds of motion data may be required for the same multimedia content. In this case, it may be difficult for a content provider to directly generate and provide all kinds of motion data.

### SUMMARY

An object of the present disclosure is to provide a content selling service operating device capable of providing a user with action robot content integrally including multimedia content and motion data with respect to an action robot having a function of outputting the multimedia content and a function of providing a motion for the multimedia content.

Another object of the present disclosure is to provide a content selling service operating device capable of providing action robot content having motion data suitable for an action robot owned by a user.

In one embodiment, a content selling service operating device includes: a communication unit connected to a terminal of a user to receive, from the terminal, a request for purchasing action robot content corresponding to multimedia content; an action robot content generation module configured to generate action robot content including motion data for the multimedia content; and a processor configured to control the communication unit to transmit the generated action robot content to an action robot or the terminal of the user.

The content selling service operating device may further include a content database (DB) management module configured to receive the multimedia content from a content providing device through the communication unit and storing content data including the received multimedia content in a content DB, wherein the action robot content generation module may be configured to generate the action robot content including the motion data and the multimedia content.

The content DB management module may be configured to receive the motion data for the multimedia content from the content providing device through the communication unit and store the content data including the multimedia content and the received motion data in the content DB.

The content DB management module may be configured to receive the motion data for the multimedia content from a motion data generation device through the communication unit and store the content data including the multimedia content and the received motion data in the content DB.

The content data may further include motion expression condition information received from the content provider, and the processor may be configured to: transmit, to the motion data generation device, the motion expression condition information for guiding the generation of the motion data; and receive, from the motion data generation device, the motion data generated based on the motion expression condition information.

The content selling service operating device may further include: a content selling management module configured to manage a sales volume of the multimedia content provided from the content providing device and a sales volume of the motion data provided from the motion data generation device; and a profit calculation module configured to calculate a profit of a content provider corresponding to the content providing device based on the sales volume of the multimedia content and calculate a profit of a motion data producer corresponding to the motion data generation device based on the sales volume of the motion data.

The content selling service operating device may further include a user DB management module configured to acquire, from a user DB, information about an action robot owned by the user, wherein the action robot content generation module may be configured to generate the action robot content including motion data corresponding to the information about the owned action robot among at least one motion data for the multimedia content.

Each of the at least one motion data may correspond to at least one of a plurality of action robots.

The content data may include the multimedia content, the at least one motion data, and action robot compatibility information for each of the at least one motion data, and the content DB management module may be configured to acquire motion data corresponding to the owned action robot information among the at least one motion data based on the owned action robot information and the action robot compatibility information.

The user DB management module may be configured to load user data of the user from the user DB, and the processor may be configured to transmit the action robot content to the action robot based on address information of the action robot included in the user data.

Each of the at least one motion data may include rotation angle information about joints of the action robot or control information about motors with respect to each of specific playback points of the multimedia content.

The processor may be configured to: receive information about the multimedia content from the action robot through the communication unit; acquire the motion data for the multimedia content from a content DB based on the received information; and transmit the acquired motion data to the action robot.

The processor may be configured to: receive, from a terminal, output data of the multimedia content provided through the action robot; recognize the multimedia content based on the received output data; and transmit motion data for the recognized multimedia content to the action robot or the terminal.

In one embodiment, an operating method of a content selling service operating device includes: receiving, from a terminal of a user, a request for purchasing action robot content corresponding to multimedia content through a communication unit; acquiring motion data for the multimedia content; generating action robot content including the acquired motion data; and transmitting the generated action robot content to an action robot or the terminal of the user.

### BRIEF DESCRIPTION OF THE DRAWINGS

FIG. 1 is a schematic block diagram illustrating an example of a system including an action robot content selling service operating device according to an embodiment of the present disclosure.

FIG. 2 is a schematic block diagram of the operating device according to an embodiment of the present disclosure.

FIG. 3 is a diagram for describing an example in which the operating device illustrated in FIG. 1 acquires action robot content from a content providing device.

FIG. 4 is a diagram for describing an example in which the operating device illustrated in FIG. 1 acquires action robot content from a content providing device and a motion data generation device.

FIG. 5 illustrates an example of a motion data generation screen provided through an application executed in the motion data generation device in connection with the embodiment of FIG. 4.

FIG. 6 is a ladder diagram illustrating an operation in which the operating device provides action robot content to a user's action robot in response to a purchase request of a user, according to an embodiment of the present disclosure.

FIG. 7 illustrates an example of a screen including a content list output on a user's terminal for purchase of action robot content.

FIG. 8 is a diagram for describing an operation in which the operating device generates and provides action robot content in connection with the embodiment of FIG. 6.

FIG. 9 illustrates an example of an operation in which an action robot, which receives action robot content from an operating device, outputs the received action robot content.

FIG. 10 is a diagram for describing an example of a business model including a content selling service operator, a content provider, a motion data producer, and a user, based on the embodiment of FIG. 6.

FIG. 11 is a flowchart for describing another embodiment in which an operating device provides action robot content.

FIG. 12 is a flowchart for describing further another embodiment in which an operating device provides action robot content.

### DETAILED DESCRIPTION OF THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the following descriptions and the accompanying drawings, descriptions of well-known functions or constructions will be omitted if they are considered to unnecessarily obscure the gist of the present disclosure. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

In the present application, the terms “comprise” or “include” and the like are intended to specify the presence of stated features, numbers, steps, operations, elements, parts, or combinations thereof, but do not preclude the presence or addition of one or more other features, numbers, steps, operations, elements, parts, or combinations thereof.

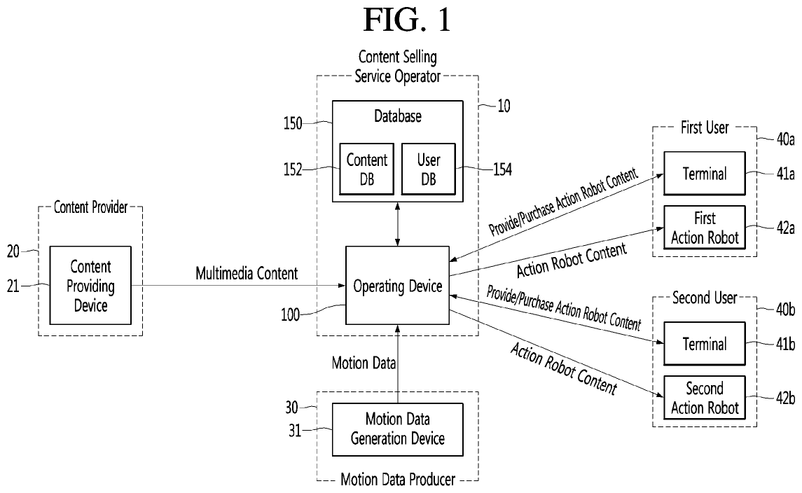

FIG. 1 is a schematic block diagram illustrating an example of a system including an action robot content selling service operating device according to an embodiment of the present disclosure.

Referring to FIG. 1, an action robot content selling service may include a content selling service operator 10 that performs overall operation and management of a content selling service, at least one content provider 20 that provides multimedia content, at least one motion data producer 30 that provides motion data corresponding to multimedia content, and users 40a and 40b who purchase and use action robot content.

The content selling service operator 10 may operate and manage the content selling service through a content selling service operating device 100 (hereinafter, referred to as an “operating device”) and a database (DB) 150. The content provider 20 may provide multimedia content and/or motion data to the operating device 100 through a content providing device 21. The motion data producer 30 may produce (generate) motion data corresponding to specific multimedia content through a motion data generation device 31 and provide the generated motion data to the operating device 100. Each of the plurality of users 40a and 40b may request purchase of action robot content to the operating device 100 through the terminals 41a and 41b and download the action robot content to the action robots 42a and 42b.

The action robot content may include multimedia content and motion data corresponding to the multimedia content. The multimedia content may include a variety of content such as music, fairy tale, education, and conversation.

For example, when the multimedia content is music, the motion data may represent dancing (choreography) corresponding to the music. When the multimedia content is the fairy tale, educational content, or conversation content, the motion data may represent various motions such as a motion, a pose, an emotional expression, or a reaction of a person or a character associated with the content.

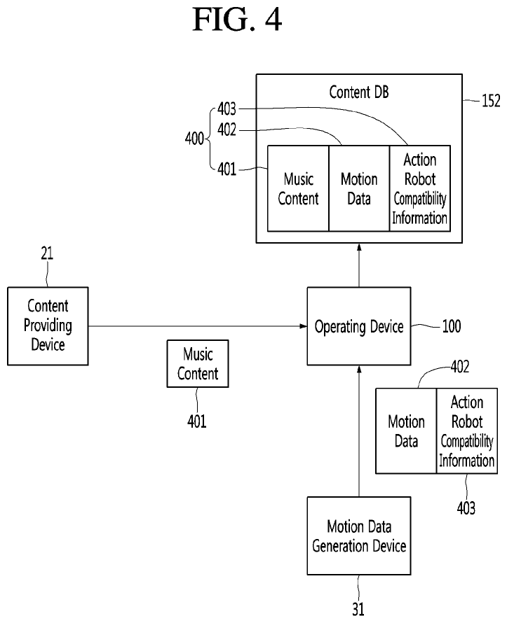

According to the embodiment, the action robot contents may include only motion data corresponding to specific multimedia content, or may include the motion data and expression condition information about the motion data. The action robot content will be described later in more detail with reference to FIGS. 3 and 4.

Hereinafter, the respective configurations illustrated in FIG. 1 will be schematically described.

The operating device 100 may provide information (list, etc.) about the action robot content (or the multimedia content) to the user's terminals 41a and 41b and receive a purchase request for purchasing the action robot content from the terminals 41a and 41b. Based on the received purchase request, the operating device 100 may generate action robot content having the motion data corresponding to the action robots 42a and 42b owned by the user, and transmit the generated action robot content to the action robots 42a and 42b. According to the embodiment, the operating device 100 may provide the generated action robot content to the action robots 42a and 42b through the terminals 41a and 41b.

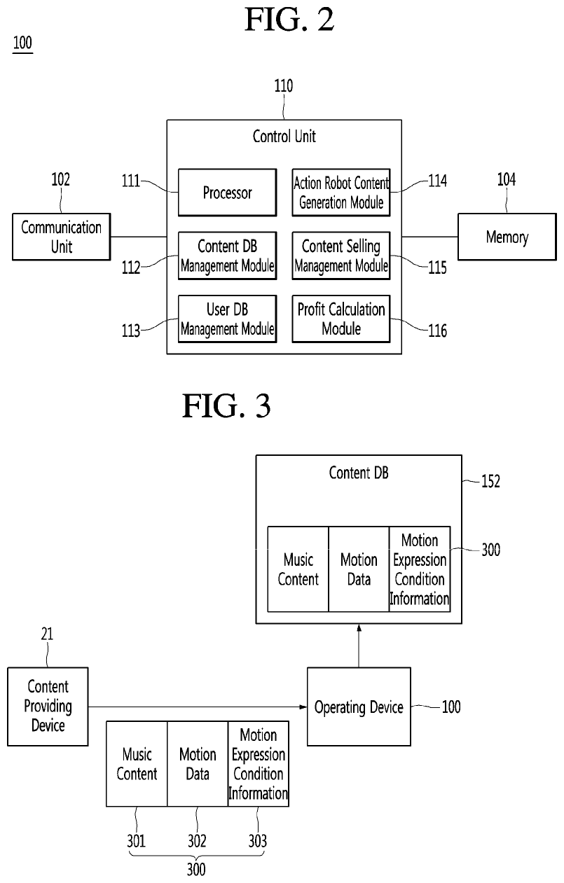

The operating device 100 may be implemented by a computing device such as a server, and may include a plurality of configurations for performing the above-described operations. The plurality of configurations will be described later in detail with reference to FIG. 2.

The database 150 may store a variety of information related to the provision of the content selling service. For example, the database 150 may include a content DB 152 and a user DB 154.

The operating device 100 may store the multimedia content acquired from the content providing device 21 of the content provider in the content DB 152. In addition, the operating device 100 may store the motion data acquired from the content providing device 21 or the motion data generation device 31 in the content DB 152.

The content DB 152 may store a plurality of pieces of content data. For example, each of the plurality of pieces of content data may include multimedia content for generating action robot content and/or at least one piece of motion data for the multimedia content. Each of the at least one piece of motion data may correspond to at least one of various types of action robots. That is, the action robot may provide a motion by processing the motion data corresponding to the action robot among the at least one piece of motion data included in the content data.

The user DB 154 may store user data of each of a plurality of users by using the content selling service. For example, the user data may include user identification information (e.g., ID), user's owned action robot information (e.g., model information), IP address information about the action robot, a user's purchase history, and the like.

According to the embodiment, the database 150 may be configured integrally with the operating device 100.

The content providing device 21 may be implemented by a computing device that provides the multimedia content to the operating device 100. For example, the content providing device 21 may be implemented by a server operated by the content provider 20. According to the embodiment, the content providing device 21 may include a terminal such as a PC, a smartphone, or a tablet PC.

The motion data generation device 31 may be implemented by a computing device that provides motion data for specific multimedia content to the operating device 100. For example, the content selling service operator 10 may provide an application for generating the motion data to the motion data generation device 31 through the operating device 100 or another computing device.

The motion data producer 30 may generate the motion data for the multimedia content through an application executed in the motion data generation device 31. The motion data generation device 31 may transmit (upload) the generated motion data to the operating device 100. The operating device 100 may store the received motion data in the content DB 152, or may store the motion data and the multimedia content corresponding to the motion data in the content DB 152 together.

Meanwhile, when the content provider 20 directly generates motion data and provides the generated motion data to the operating device 100, the content provider 20 may be included in the motion data producer 30.

The terminals 41a and 41b may provide a list of multimedia content corresponding to purchasable action robot content and may receive a purchase requests for specific action robot content from the users 40a and 40b. The terminals 41a and 41b may include a smartphone, a tablet PC, a notebook PC, a PC, and the like.

For example, the list may include a list of at least one piece of multimedia content in which corresponding motion data is present in the database 150. The purchase request for the action robot content corresponding to the multimedia content may be input in such a manner that the terminals 41a and 41b output the list through a display or the like and the user selects desired multimedia content from at least one piece of multimedia content included in the list, The terminals 41a and 41b may transmit the input purchase request to the operating device 100.

The operating device 100 may transmit the action robot content to the user's action robots 42a and 42b based on the received purchase request.

The action robots 42a and 42b correspond to robots that control movement of at least one joint through a robot driving unit having an actuator module including a plurality of motors and perform operations such as dancing or motion. In addition, the action robots 42a and 42b may include a speaker and/or a display for outputting multimedia content implemented in a visual or auditory form such as music or video. Therefore, the action robots 42a and 42b may process and output the multimedia content included in the action robot content and the corresponding motion data, thereby making it possible to provide more live content to the user.

According to the embodiment, the action robots 42a and 42b may include an action robot implemented on a robot simulator included in a computing device (PC, etc.). The robot simulator may output the action robots 42a and 42b in a graphical form through a display of the computing device.

FIG. 2 is a schematic block diagram of the operating device according to an embodiment of the present disclosure.

Referring to FIG. 2, the operating device 100 may include a communication unit 102, a memory 104, and a control unit 110. The configurations illustrated in FIG. 2 are not essential for implementing the operating device 100, and the operating device 100 may include more or fewer components.

The communication unit 102 may include at least one communication module for connecting the operating device 100 to the database 150 or connecting the operating device 100 to the content providing device 21, the motion data generation device 31, the terminals 41a and 41b, the action robots 42a and 42b, or the like through the network. For example, the communication unit 102 may include a wireless communication supporting module, for example, a wireless Internet module such as Wi-Fi or a mobile communication module such as Long Term Evolution (LTE), or a wired communication supporting module such as a wired Internet module.

As described above with reference to FIG. 1, the operating device 100 may receive multimedia content and/or motion data from the content providing device 21 connected through the communication unit 102, or may receive motion data from the motion data generation device 31. In addition, the operating device 100 may transmit a list of multimedia content corresponding to the purchasable action robot content to the terminals 41a and 41b connected through the communication unit 102, or may receive a purchase request for the action robot content from the terminals 41a and 41b. In addition, the operating device 100 may transmit the action robot content to the action robots 42a and 42b through the communication unit 102.

The memory 104 may store various data such as control data for controlling the operations of the components included in the operating device 100, and data for performing an operation corresponding to a request or a command acquired through the communication unit 102.

In addition, the memory 104 may store program data for the operations of a content DB management module 112, a user DB management module 113, an action robot content generation module 114, a content selling management module 115, and a profit calculation module 116. The processor 111 of the control unit 110 or other controllers may control the operation of each of the modules 112 to 116 based on the program data.

According to the embodiment, when the database 150 of FIG. 1 is implemented in an integral structure with the operating device 100, the memory 104 may be understood as including the database 150 as well.

The memory 104 may include various storage devices such as ROM, RAM, EPROM, flash drive, or hard drive in hardware.

The control unit 110 may include at least one processor or controller for controlling the operation of the motion generation device 20. Specifically, each of the at least one processor or controller may be implemented by a CPU, an application processor (AP), a microcomputer (or a micom), an integrated circuit, an application specific integrated circuit (ASIC), or the like.

For example, the processor 111 included in the control unit 110 may control the overall operations of the configurations included in the operating device 100.

In particular, the processor 111 may execute each of the modules 112 to 116 when the program data of each of the modules 112 to 116 stored in the memory 104 is loaded. That is, the operation of each of the modules 112 to 116 may be controlled by the processor 111 or another processor or controller included in the control unit 110.

The content DB management module 112 may manage a plurality of pieces of content data. For example, the content DB management module 112 may generate, modify, or delete the plurality of pieces of content data stored in the content DB 152.

Specifically, the content DB management module 112 may generate content data including the multimedia content received from the content providing device 21 and the motion data for the multimedia content provided from the motion data generation device 31, and store the generated content data in the content DB 152. According to the embodiment, the motion data may be received from the content providing device 21.

The content data may include a plurality of pieces of motion data corresponding to the multimedia content. The plurality of pieces of motion data may be received from at least one motion data generation device 31. Each of the plurality of pieces of motion data may correspond to at least one of various kinds of action robots.

When the motion data for the multimedia content stored in the content DB 152 is additionally received from the motion data generation device 31, the content DB management module 112 may modify the content data corresponding to the multimedia content so as to include the received motion data.

In addition, the content DB management module 112 may delete the multimedia content and/or motion data stored in the content DB 152 in response to the deletion request received from the content providing device 21 or the motion data generation device 31.

Meanwhile, the content DB management module 112 may load the content data corresponding to the purchase request from the content DB 152 in response to the purchase request received from the user terminal. The content DB management module 112 may provide the multimedia content and the motion data included in the loaded content data to the action robot content generation module 114. According to the embodiment, when the plurality of pieces of motion data are included in the content data, the content DB management module 112 may provide motion data corresponding to the user's action robot to the action robot content generation module 114.

The operation related to the content DB management module 112 will be described later in more detail with reference to other drawings.

The user DB management module 113 may manage generation, modification, deletion, etc. of the plurality of pieces of user data stored in the user DB 154.

In particular, the user DB management module 113 may load user data for the user from the user DB 154 in response to the purchase request of the action robot content received from the user terminal.

The user DB management module 113 may provide, to the content DB management module 112, action robot information (e.g., model information) included in the loaded user data. In addition, the user DB management module 113 may provide, to the processor 111, address information (e.g., IP address) of the action robot included in the loaded user data.

The action robot content generation module 114 may generate action robot content including the multimedia content and the motion data provided from the content DB management module 112. According to the embodiment, when there are a plurality of pieces of motion data corresponding to the user's action robot, the action robot content generation module 114 may generate action robot content including motion data selected by the user through the terminal from among the plurality of pieces of motion data.

When the action robot content is generated by the action robot content generation module 114, the processor 111 may transmit the action robot content to the user's action robot based on the address information about the action robot.

Meanwhile, the operating device 100 may calculate the profit of the content provider 20 and the motion data producer 30 based on sales information about the multimedia content and the motion data included in the action robot content.

The content selling management module 115 may manage sales information (e.g., sales volume) of each of the multimedia content and the motion data provided (sold) to the action robots of the users.

The profit calculation module 116 may calculate the profit of the content provider 20 based on the sales volume of the multimedia content and calculate the profit of the motion data producer 30 based on the sales volume of the motion data. The content selling service operator 10 may provide a fee corresponding to each profit to the content provider 20 and the motion data producer 30 based on the profit calculated by the profit calculation module 116.

FIG. 3 is a diagram for describing an example in which the operating device illustrated in FIG. 1 acquires the multimedia content and the motion data from the content providing device.

In the following drawings, it is assumed that the multimedia content is music content. However, the following embodiments may be equally applied to a variety of multimedia content (education content, conversation content, game content, fairy tale content, etc.) other than the music content.

Referring to FIG. 3, the multimedia content and the motion data may be provided from the content providing device 21. That is, the content provider 20 may directly generate motion data for the multimedia content through the content providing device 21 and provide the generated motion data to the operating device 100.

The operating device 100 may receive content data 300 including multimedia content (e.g., music content 301) and motion data 302 from the content providing device 21 and store the received content data 300 in the content DB 152.

According to the embodiment, the content data 300 may further include motion expression condition information 303. The motion expression condition information 303 may include information about main motion and guide information for allowing the motion data producer 30 to generate the motion data for the multimedia content 301.

Specifically, the motion data 302 may include control values (e.g., rotation angles) of joints for motion associated with the music content 301, or control information about the motors. In this case, the motion data 302 may be processed by the action robot including the joints, and may not be processed by the action robot that does not include some of the joints.

Therefore, the motion expression condition information 303 may include guide information for implementing the main motion among the motions related to the multimedia content 301, rotation angle information about each of the joints, and the like.

According to the embodiment, the motion data 302 provided from the content providing device 21 may be not the motion data corresponding to the specific action robot but reference motion data for generating the motion data corresponding to each of the action robots.

The processor 111 may provide the motion expression condition information 303 or the reference motion data to the motion data generation device 31. The motion data producer may more conveniently generate the motion data corresponding to the specific action robot based on the motion expression condition information 303 or the reference motion data.

FIG. 4 is a diagram for describing an example in which the operating device illustrated in FIG. 1 acquires the multimedia content and the motion data from the content providing device and the motion data generation device.

Referring to FIG. 4, the operating device 100 may acquire multimedia content (e.g., music content 401) from the content providing device 21 and generate motion data 402 for the music content 401 from the motion data generation device 31.

The operating device 100 may store the content data 400 including the acquired music content 401 and the acquired motion data 402 in the content DB 152. According to the embodiment, the operating device 100 may acquire different motion data 402 for the music content 401 from a plurality of motion data generation devices. In this case, the content data 400 may include a plurality of pieces of motion data.

For example, when there are various kinds of action robots and the joint position or the number of the action robots is different from each other, motion data corresponding to each of the action robots may be required. Since it may be difficult for the content provider 20 to produce a plurality of pieces of motion data corresponding to each of the action robots, the motion data 402 may be generated and provided by a plurality of motion data producers.

According to the embodiment, the operating device 100 may acquire more action robot compatibility information 403 for the motion data 402 from the motion data generation device 31. The operating device 100 may store the content data 400 including the music content 401, the motion data 402, and the action robot compatibility information 403 in the content DB 152.

The action robot compatibility information 403 may include information (e.g., model information, etc.) about at least one action robot capable of processing the motion data 402. According to the embodiment, the action robot compatibility information 403 may correspond to the motion expression condition information 303 in FIG. 3.

According to another embodiment, content data 400 may not include multimedia content. In this case, the content data 400 may include information indicating which multimedia content the motion data 402, the action robot compatibility information 403, and the motion data 402 correspond to.

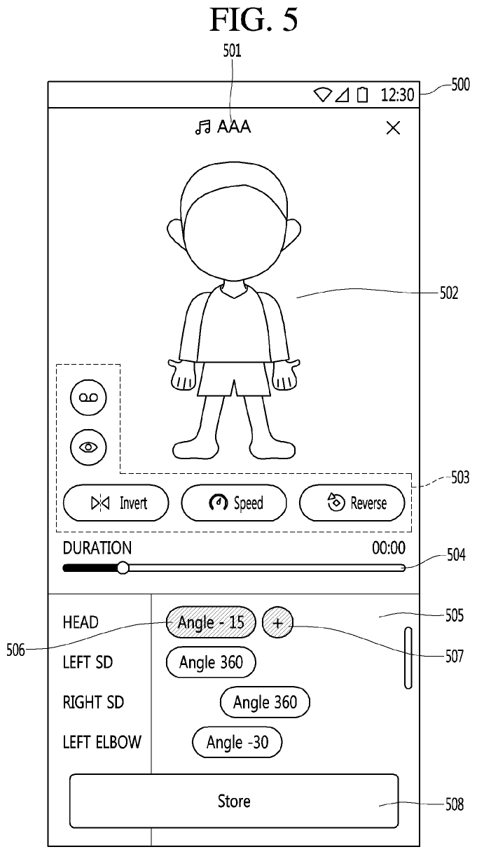

FIG. 5 illustrates an example of a motion data generation screen provided through an application executed in the motion data generation device in connection with the embodiment of FIG. 4.

As described above with reference to FIG. 1, the content selling service operator 10 may provide an application for generating motion data to the motion data generation device 31 through the operating device 100 or another computing device.

Referring to FIG. 5, the motion data generation device 31 may display a motion data generation screen 500 for generating motion data through a display according to execution of the application. The motion data generation screen 500 illustrated in FIG. 5 is only one embodiment for convenience of explanation, and the configuration or the type of the motion data generation screen are not limited to the embodiment of FIG. 5.

For example, the motion data generation screen 500 may include multimedia content information 501 (e.g., a music title) corresponding to motion data to be generated, a simulator 502, at least one function icon 503 associated with the simulator 502 or a motion setting, a time stamp 504 for selecting a playback point of the multimedia content corresponding to a specific motion, and a motion setting window 505 for setting rotation angle information about joints for each of the plurality of playback points.

The motion data producer may select any one of the plurality of action robots and generate motion data corresponding to the selected action robot. In this case, the simulator 502 of the selected action robot may be displayed on the motion data generation screen 500.

The motion data producer may manipulate the simulator 502 to set the motion at each of the specific time points. In this case, rotation angle information about each of the joints included in the motion setting window 505 may be automatically set to correspond to the set motion.

In addition, the simulator 502 may provides the motion based on the rotation angle information at predetermined time points of each joint set through the motion setting window 505, thereby allowing the motion data producer to previously confirm the motion to be implemented through the action robot. The motion data producer may modify the rotation angle information or generate the motion data based on the motion provided by the simulator 502.

According to the embodiment, the motion data producer may directly set the rotation angle of each joint through the motion setting window 505. For example, the motion data producer may set the rotation angle of the head 506 at a specific playback point and may set the rotation angle information about the head at the specific playback point by selecting an additional item 507.

When a storage button 508 included in the motion data generation screen 500 is selected, the motion data generation device 31 may generate motion data including the rotation angle information set through the motion setting window 505.

Although not illustrated, the motion data producer may additionally set sales price of motion data, editability of others for motion data, and the like through the motion data generation device 31.

The motion data generation device 31 may transmit the generated motion data to the operation device 100.

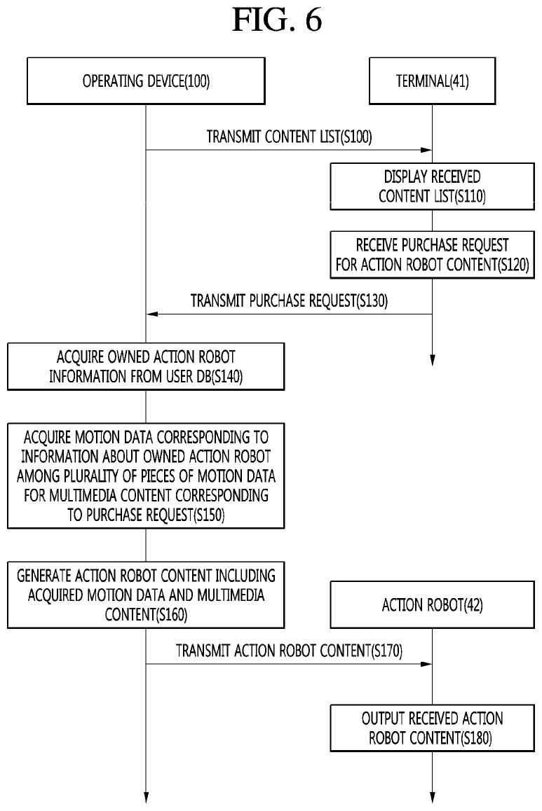

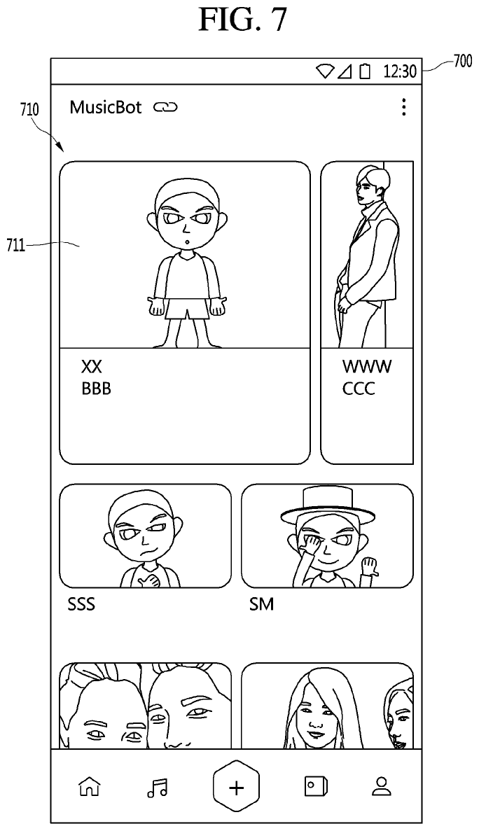

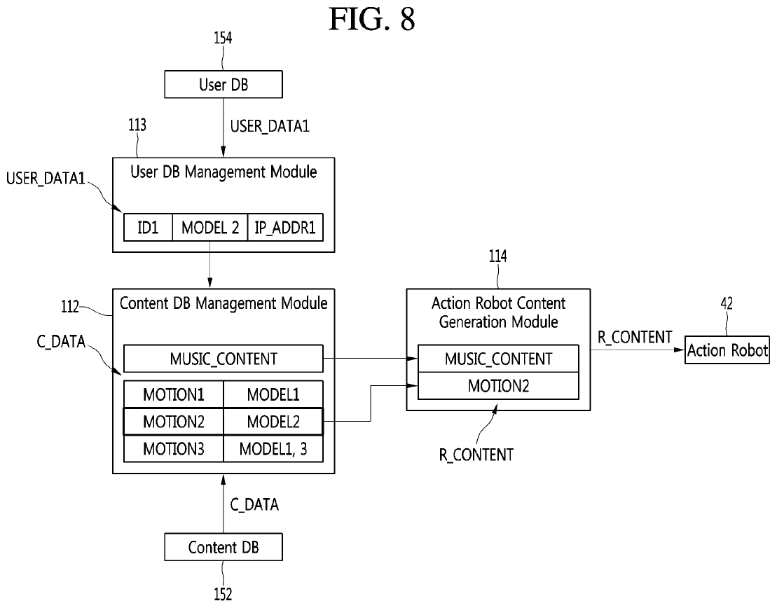

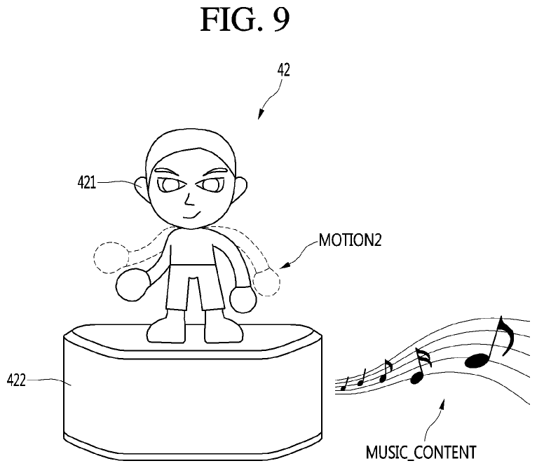

FIG. 6 is a ladder diagram illustrating an operation in which the operating device provides action robot content to a user's action robot in response to a purchase request of a user, according to an embodiment of the present disclosure. FIG. 7 illustrates an example of a screen including a content list output on a user's terminal for purchase of action robot content. FIG. 8 is a diagram for describing an operation in which the operating device generates and provides action robot content in connection with the embodiment of FIG. 6. FIG. 9 illustrates an example of an operation in which an action robot, which receives action robot content from an operating device, outputs the received action robot content.

Referring to FIG. 6, when the user executes a content selling service application installed on the terminal 41, the terminal 41 may access the operating device 100.

The operating device 100 may transmits the content list to the connected terminal 41 (S100) and the terminal 41 may output the received content list on the display (S110).

As described above with reference to FIG. 1, the content list may include a list of at least one multimedia content in which corresponding motion data is present.

The content DB management module 112 of the operating device 100 may generate the content list based on the content data stored in the content DB 152. The processor 111 may control the communication unit 102 to transmit the content list generated by the content DB management module 112 to the terminal 41.

The terminal 41 may output the list of at least one multimedia content included in the received content list through the display or the like.

The terminal 41 may receive the purchase request for the action robot content from the user (S120), and may transmit the received purchase request to the operating device 100 (S130).

The user may select a multimedia content item corresponding to the action robot content to be purchased among the output list. The terminal 41 may transmit, to the operation device 100, the purchase request for the action robot content corresponding to the selected multimedia content item.

Referring to FIG. 7 with respect to operations S100 to S130, the terminal 41 may receive the content list from the operating device 100. The terminal 41 may display a screen 700 for acquiring the purchase request from the user based on the received content list through the display.

For example, the screen 700 may include a list 710 of multimedia content corresponding to each of at least one purchasable action robot content. Each of the items included in the list 710 may include a thumbnail, a graphic image, or a text indicating the corresponding multimedia content.

Based on the displayed list 710, the user may select an item (e.g., a first item 711) indicating multimedia content corresponding to the action robot content to be purchased. Although not illustrated, when the first item 711 is selected, the terminal 41 may display a screen (or a window, etc.) for confirming whether to purchase the action robot content corresponding to the selected first item 711, and may receive the purchase request based on the displayed screen.

The terminal 41 may transmit the purchase request for the action robot content corresponding to the first item 711 to the operating device 100 in response to the purchase request of the first item 711.

FIG. 6 is described again.

The operating device 100 may acquire the owned action robot information from the user DB 154 (S140).

The user DB management module 113 of the operating device 100 may load the user data of the user from the user DB 154 and acquire the owned action robot information in the loaded user data.

According to the embodiment, operation S140 may be performed when the terminal 41 connects to the operating device 100. That is, when the terminal 41 connects to the operating device 100, the user DB management module 113 may load user data for the user of the connected terminal 41 from the user DB 154.

The operating device 100 may acquire motion data corresponding to the owned action robot information among a plurality of pieces of motion data for the multimedia content corresponding to the received purchase request (S150).

The content DB management module 112 may, from the content DB 152, load content data including the multimedia content corresponding to the purchase request. The content DB management module 112 may acquire the motion data corresponding to the owned action robot information acquired by the user DB management module 113 among the plurality of pieces of motion data (or at least one piece of motion data) included in the loaded content data. The acquired motion data corresponds to motion data that can be processed by the action robot owned by the user.

The operation device 100 may generate the action robot content including the acquired motion data and the acquired multimedia content (S160), and may transmit the generated action robot content to the action robot 42 of the user (S170).

The action robot content generation module 114 of the operating device 100 may generate action robot content including the multimedia content included in the content data and the motion data obtained in operation S150. According to the embodiment, the content data may not include multimedia content. In this case, the action robot content may include information about the motion data and the multimedia content corresponding to the motion data.

The processor 111 may transmit the generated action robot content to the action robot 42 of the user based on the address information about the action robot included in the user data. According to the embodiment, the processor 111 may transmit the action robot content to the terminal 41 of the user. In this case, the terminal 41 may transmit the received action robot content to the action robot 42.

Meanwhile, when there are a plurality of pieces of motion data corresponding to the owned action robot information in operation S150, the processor 111 may transmit a selection request for any one of the plurality of pieces of motion data to the terminal 41, and receive a response to selection request from the terminal 41. The action robot content generation module 114 may generate action robot content including the multimedia content and any motion data selected based on the received response.

Referring to FIG. 8 with respect to operations S140 to S170, the user DB management module 113 may load first user data USER_DATA1 corresponding to the user of the terminal 41 that has transmitted the purchase request among the user data of the plurality of users stored in the user DB 154.

For example, the first user data USER_DATA1 may include identification information about the user (for example, ID ID1), owned action robot information (for example, a second model MODEL2 as model information), and address information IP_ADDR1 about the owned action robot.

The user DB management module 113 may provide, to the content DB management module 112, the owned action robot information indicating the second model MODEL2 among the loaded first user data USER_DATA1.

The content DB management module 112 may load the content data C_DATA including the multimedia content corresponding to the purchase request among the plurality of pieces of content data stored in the content DB 152.

For example, the content data C_DATA may include a plurality of pieces of motion data MOTION1, MOTION2, MOTION3 corresponding to multimedia content (e.g., music content MUSIC_CONTENT) and music content MUSIC_CONTENT, and action robot compatibility information for each of the plurality of pieces of motion data MOTION1, MOTION2, and MOTION3.

According to the embodiment of FIG. 8, the first motion data MOTION1 among the plurality of pieces of motion data may correspond to the action robot of the first model MODEL1, the second motion data MOTION2 may correspond to the action robot of the second model MODEL2, and the third motion data MOTION3 may correspond to the action robot of the first model MODEL1 and the action robot of the third model MODEL3.

The content DB management module 112 may provide the music content MUSIC_CONTENT included in the content data C_DATA to the action robot content generation module 114. In addition, the content DB management module 112 may provide, to action robot content generation module 114, the second motion data MOTION2 corresponding to the action robot of the second model MODEL2 owned by the user among the plurality of pieces of motion data based on the owned action robot information (the second model MODEL2) provided from the user DB management module 113.

The action robot content generation module 114 may generate action robot content R_CONTENT including the music content MUSIC_CONTENT and the second motion data MOTION2. The processor 111 may transmit the action robot contents R_CONTENT to the action robot 42 based on the address information IP_ADDR1 included in the first user data USER_DATA1.

FIG. 6 is described again.

The action robot 42 may output the received action robot content (S180), and may output the multimedia content and the motion according to the motion data.

For example, when the multimedia content is music content, the action robot 42 may output the music content through a sound output unit such as a speaker. In addition, the action robot 42 may provide the motion corresponding to the music content by controlling the robot driving unit based on the motion data.

Referring to FIG. 9 with respect to operation S180, the action robot 42 may include a robot module 421 having at least one joint controlled by a robot driving unit (not illustrated), and a main body 422 including a robot driving unit and a speaker.

The action robot 42 may output the multimedia content and the motion data included in the action robot content received from the operating device 100.

Specifically, the action robot 42 may output (play back) the multimedia content (e.g., music content) through the speaker of the main body 422.

In addition, the action robot 42 may control the robot driving unit based on the rotation angle set for each of the joints at predetermined points during the output of the multimedia content. The robot driving unit may drive each of the plurality of motors based on the set rotation angle such that the robot module 421 can take the set motion. Through the action robot 42, the user may utilize more dynamic multimedia content, and thus the user's satisfaction and interest in the action robot 42 may be enhanced.

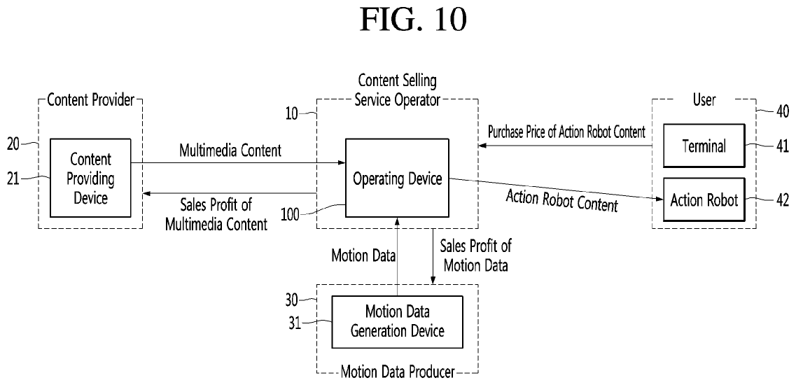

FIG. 10 is a diagram for describing an example of a business model including a content selling service operator, a content provider, a motion data producer, and a user, based on the embodiment of FIG. 6.

Referring to FIG. 10, the content provider 20 may provide the multimedia content to the operating device 100 through the content providing device 21, and the motion data producer 30 may provide the motion data to the operating device 100 through the motion data generation device 31.

The operating device 100 may provide the action robot content including the multimedia content and the motion data to the action robot 42 (or the terminal 41) of the user 40 in response to the purchase request of the user 40. At this time, the operating device 100 may manage the sales volume of each of the multimedia content and the motion data and calculate the profit of each of the content provider 20 and the motion data producer 30 based on the sales volume through the content selling management module 115 and the profit calculation module 116.

The user 40 may pay the purchase price corresponding to the purchase of the action robot content to the content selling service operator 10. A part of the purchase price may be included in the sales profit of the content provider 20, other part of the purchase price may be included in the sales profit of the motion data producer 30, and the others may be included in the operating profit of the content selling service operator 10.

The content selling service operator 10 may provide, to the content provider 20, the sales profit of the multimedia content of the content provider 20 calculated by the profit calculation module 116. The content selling service operator 10 may provide, to the motion data producer 30, the motion data sales profit of the motion data producer 30 calculated by the profit calculation module 116.

That is, the user 40 may purchase and use the action robot content including the motion data of the action robot 42 and the multimedia content through the content selling service according to the embodiment of the present disclosure. By purchasing the action robot content, each of the content provider 20 and the motion data producer 30 may acquire a predetermined sales profit.

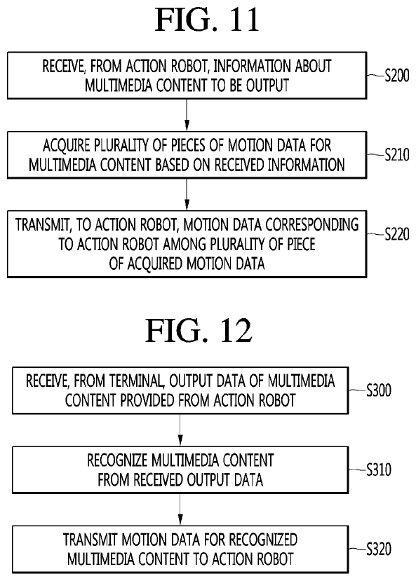

FIG. 11 is a flowchart for describing another embodiment in which an operating device provides action robot content.

Referring to FIG. 11, the operating device 100 may receive information about multimedia content to be output by an action robot (or the terminal) (or multimedia content being output) from the action robot (or the terminal) (S200).

For example, the action robot 42 (see FIG. 10) may output the multimedia content stored in the memory or the multimedia content provided from an external device or a server connected to the action robot 42.

The action robot 42 may transmit information about the multimedia content to the operating device 100 so as to provide a motion (action, etc.) corresponding to the multimedia content. According to the embodiment, the user 40 may transmit information about the multimedia content to be output by the action robot 42 to the operating device 100 through the terminal 41 (see FIG. 10).

Based on the received information, the operating device 100 may acquire a plurality of pieces of motion data for the multimedia content (S210).

The content DB management module 112 of the operating device 100 may load the content data corresponding to the multimedia content among a plurality of pieces of content data stored in the content DB 152 based on the information about the multimedia content received from the action robot 42 or the terminal 41. As described above, the plurality of pieces of motion data for the multimedia content may be included in the content data.

The operating device 100 may transmit the motion data corresponding to the action robot among the plurality of pieces of acquired motion data to the action robot (S220).

The content DB management module 112 may acquire motion data corresponding to the action robot 42 from the plurality of pieces of motion data for the multimedia content.

The processor 111 may transmit the acquired motion data to the action robot 42 (or the terminal 41).

When outputting the multimedia content stored in the memory or the multimedia content provided from the external device or the server connected to the action robot 42, the action robot 42 may simultaneously provide motion based on the motion data acquired from the operating device 100.

FIG. 12 is a flowchart for describing another embodiment in which an operating device provides action robot content.

Referring to FIG. 12, the operating device 100 may receive, from the user terminal, output data of the multimedia content output from the action robot (S300).

For example, the terminal 41 may acquire the output data of the multimedia content provided by the action robot 42 by using a microphone or the like.

The terminal 41 may transmit the acquired output data to the operating device 100.

The operating device 100 may recognize the multimedia content from the received output data (S310).

The operating device 100 may recognize the multimedia content corresponding to the output data based on signal characteristics, patterns, and the like included in the received output data. For example, the processor 111 of the operating device 100 or the recognition module executed by the processor 111 may recognize the multimedia content corresponding to the output data through a recognition algorithm such as a known sound recognition algorithm or a voice recognition algorithm.

The operating device 100 may transmit the motion data for the recognized multimedia content to the action robot 42 (S320).

The content DB management module 112 of the operating device 100 may load the content data corresponding to the recognized multimedia content from the content DB 152. The content DB management module 112 may acquire motion data corresponding to the action robot 42 from the plurality of pieces of motion data for the multimedia content.

The processor 111 may transmit the acquired motion data to the action robot 42. The action robot 42 may provide the motion corresponding to the multimedia content being output, based on the received motion data.

In other words, according to the embodiment of FIGS. 11 and 12, the operating device 100 may provide the multimedia data to be output by the action robot 42 or the motion data for the multimedia content being output. Therefore, the user may easily receive the motion of the action robot 42 according to the motion data, while minimizing troublesome operations for purchasing the motion data, without any additional action.

According to an embodiment of the present disclosure, a content selling service operating device generates action robot content including multimedia content and motion provided through the action robot and provides the generated action robot content to the user, thereby increasing the convenience of using the content through the action robot.

In addition, the content selling service operating device may support motion data for various kinds of action robots by providing motion data corresponding to the action robots owned by the user among a plurality of pieces of motion data for multimedia content.

In addition, the content selling service operating device may generate and sell action robot content including multimedia content provided from a content provider and motion data provided from a motion data producer, thereby generating a profit for each of the content provider and the motion data producer.

Furthermore, the content selling service operating device may provide motion data for multimedia content to be output by the action robot or multimedia content being output. Therefore, the user may easily receive the motion of the action robot according to the motion data, while minimizing troublesome operations for purchasing the motion data, without any additional action.

The above description is merely illustrative of the technical idea of the present disclosure, and various modifications and changes may be made thereto by those skilled in the art without departing from the essential characteristics of the present disclosure.

Therefore, the embodiments of the present disclosure are not intended to limit the technical spirit of the present disclosure but to illustrate the technical idea of the present disclosure, and the technical spirit of the present disclosure is not limited by these embodiments.

The scope of protection of the present disclosure should be interpreted by the appending claims, and all technical ideas within the scope of equivalents should be construed as falling within the scope of the present disclosure.

What is claimed is:

1. A content selling service operating device comprising:
a communication interface connected to a terminal of a user to receive, from the terminal, a request for purchasing action robot content corresponding to multimedia content;
an action robot content generator configured to generate action robot content including motion data for the multimedia content; and
a processor configured to control the communication interface to transmit the generated action robot content to an action robot or the terminal of the user.

2. The content selling service operating device according to claim 1, further comprising a content database (DB) manager configured to receive the multimedia content from a content providing device through the communication interface and storing content data including the received multimedia content in a content DB,
wherein the action robot content generator is configured to generate the action robot content including the motion data and the multimedia content.

3. The content selling service operating device according to claim 2, wherein the content DB manager is configured to receive the motion data for the multimedia content from the content providing device through the communication interface and store the content data including the multimedia content and the received motion data in the content DB.

4. The content selling service operating device according to claim 2, wherein the content DB management module is configured to receive the motion data for the multimedia content from a motion data generation device through the communication unit and store the content data including the multimedia content and the received motion data in the content DB.

5. The content selling service operating device according to claim 4, wherein the content data further includes motion expression condition information received from the content provider, and
the processor is configured to:
transmit, to the motion data generation device, the motion expression condition information for guiding the generation of the motion data; and
receive, from the motion data generation device, the motion data generated based on the motion expression condition information.

6. The content selling service operating device according to claim 4, further comprising:
a content selling manager configured to manage a sales volume of the multimedia content provided from the content providing device and a sales volume of the motion data provided from the motion data generation device; and
a profit calculator configured to calculate a profit of a content provider corresponding to the content providing device based on the sales volume of the multimedia content and calculate a profit of a motion data producer corresponding to the motion data generation device based on the sales volume of the motion data.

7. The content selling service operating device according to claim 1, further comprising a user DB manager configured to acquire, from a user DB, information about an action robot owned by the user,
wherein the action robot content generator is configured to generate the action robot content including motion data corresponding to the information about the owned action robot among at least one motion data for the multimedia content.

8. The content selling service operating device according to claim 7, wherein each of the at least one motion data corresponds to at least one of a plurality of action robots.

9. The content selling service operating device according to claim 8, further comprising a content DB manager configured to receive the multimedia content from a content providing device through the communication interface and store content data including the received multimedia content in a content DB,
wherein the content data includes the multimedia content, the at least one motion data, and action robot compatibility information for each of the at least one motion data, and
the content DB manager is configured to acquire motion data corresponding to the owned action robot information among the at least one motion data based on the owned action robot information and the action robot compatibility information.

10. The content selling service operating device according to claim 7, wherein the user DB manager is configured to load user data of the user from the user DB, and
the processor is configured to transmit the action robot content to the action robot based on address information of the action robot included in the user data.

11. The content selling service operating device according to claim 7, wherein each of the at least one motion data includes rotation angle information about joints of the action robot or control information about motors with respect to each of specific playback points of the multimedia content.

12. The content selling service operating device according to claim 1, wherein the processor is configured to:
receive information about the multimedia content from the action robot through the communication interface;
acquire the motion data for the multimedia content from a content DB based on the received information; and
transmit the acquired motion data to the action robot.

13. The content selling service operating device according to claim 1, wherein the processor is configured to:
receive, from a terminal, output data of the multimedia content provided through the action robot;
recognize the multimedia content based on the received output data; and
transmit motion data for the recognized multimedia content to the action robot or the terminal.

14. An operating method of a content selling service operating device, the operating method comprising:
receiving, from a terminal of a user, a request for purchasing action robot content corresponding to multimedia content through a communication interface;
acquiring motion data for the multimedia content;
generating action robot content including the acquired motion data; and
transmitting the generated action robot content to an action robot or the terminal of the user.

15. The operating method according to claim 14, further comprising:
receiving the multimedia content from a content providing device through the communication interface; and
storing content data including the received multimedia content in a content DB,
wherein the action robot content includes the multimedia content and the acquired motion data.

16. The operating method according to claim 15, wherein the storing of the content data in the content DB comprises:
receiving motion data corresponding to the multimedia content from at least one motion data generation device through the communication interface; and
storing content data including the multimedia content and the received motion data in the content DB.

17. The operating method according to claim 15, wherein the acquiring of the motion data comprises:
acquiring owned action robot information from user data of the user stored in a user DB; and
acquiring motion data corresponding to the owned action robot information among at least one motion data for the multimedia content.

18. The operating method according to claim 17, wherein the content data further includes action robot compatibility information for each of the at least one motion data, and
the acquiring of the motion data corresponding to the owned action robot information includes acquiring motion data corresponding to the owned action robot information among the at least one motion data, based on the owned action robot information and the action robot compatibility information.

19. The operating method according to claim 14, further comprising:
receiving information about the multimedia content from the action robot through the communication interface;
acquiring the motion data for the multimedia content from a content DB based on the received information; and
transmitting the acquired motion data to the action robot or the terminal.

20. The operating method according to claim 14, further comprising:
receiving output data of the multimedia content provided through the action robot;
recognizing the multimedia content based on the received output data; and
transmitting motion data for the recognized multimedia content to the action robot or the terminal.
